(19) United States
(12) Patent Application Publication
(10) Pub. No.: US 2022/0236760 A1
(43) Pub. Date: Jul. 28, 2022

(54) Joystick with Adjustable Operating Force for Electrical Wheelchair Devices

(71) Applicant: Curtis Instruments, Inc., Mount Kisco, NY (US)

(72) Inventors: Thomas Stucki, Utzenstorf (CH); Marcel Scharen, Wiedlisbach (CH)

(73) Assignee: Curtis Instruments Inc.

(21) Appl. No.: 17/159,660

(22) Filed: Jan. 27, 2021

(51) Int. Cl. G05G 5/03; A61G 5/04; G05G 1/04; G05G 5/05

(52) U.S. Cl. CPC G05G 5/03; A61G 5/04; G05G 1/04; G05G 2700/02; A61G 2203/14; G05G 2505/00; G05G 5/05

(57) ABSTRACT

A joystick for an electrically-powered wheelchair includes a shaft pivotally mounted in a base and configured to control a movement of the electrically-powered wheelchair; a reset sleeve positioned over a lower portion of the shaft proximate the base; a compression spring positioned over the shaft with one end of the compression spring compressed against or fixed to an upper portion of the shaft and an opposing end of the compression spring compressed against the reset sleeve; and a flexible clip positioned over the shaft at the opposing end of the compression spring and between the compression spring and the reset sleeve, the flexible clip being removably positioned on the shaft so as to compress the compression spring between the flexible clip and a point at which the compression spring is compressed against or fixed to the upper portion of the shaft.

### BACKGROUND

### Technical Field

The example and non-limiting embodiments disclosed herein relate generally to electrically-powered wheelchairs and, more particularly, to joysticks for controlling electrically-powered wheelchairs.

### Brief Description of Prior Developments

Powered personal mobility vehicles, such as electrically-powered wheelchairs having self-contained power sources that provide drive power to wheels and steering actuators, may include various user interface systems to control the drive power and motive subsystems of the vehicles. These user interface systems allow a user to interact with the vehicle through an input device to execute start, stop, and steer functions.

Users with varying degrees of disability may desire the input device to be in the form of a joystick or similar type of hand control. For users of electric wheelchairs, it is desirable to have the option of adapting the operating force of the joystick to their ability. To adapt the operating force of the joystick in a current wheelchair, a spring that is provided with the joystick may need to be replaced, with the replacement spring being selected to match the user's hand mobility/strength. However, a suitable replacement spring that corresponds to the user's ability is often not included with the joystick. If it is included, the replacement of one spring for another is often not something that the user can easily do. This generally leads to original equipment manufacturers and dealers having to stock and supply different springs so that a joystick can be altered by a qualified technician at the request of the user. Accordingly, there is a need to provide joysticks and other wheelchair controls with improved and easily-interchangeable hand control mechanisms that can be configured by the user.

### SUMMARY

The following summary is merely intended to be exemplary. The summary is not intended to limit the scope of the claims.

In accordance with one aspect, an example joystick for an electrically-powered wheelchair comprises: a shaft pivotally mounted in a base and configured to control a movement of the electrically-powered wheelchair; a reset sleeve positioned over a lower portion of the shaft proximate the base; a compression spring positioned over the shaft with one end of the compression spring compressed against or fixed to an upper portion of the shaft and an opposing end of the compression spring compressed against the reset sleeve; and a flexible clip positioned over the shaft at the opposing end of the compression spring and between the compression spring and the reset sleeve, the flexible clip being removably positioned on the shaft so as to compress the compression spring between the flexible clip and a point at which the compression spring is compressed against or fixed to the upper portion of the shaft. A compression or a relaxation of the compression spring alters an operational force used to move the shaft relative to the base.

In accordance with another aspect, a joystick for an electrically-powered wheelchair comprises: a shaft pivotally mounted in a base and configured to control a movement of the electrically-powered wheelchair; a collar threadedly received on an upper portion of the shaft; a reset sleeve positioned over a lower portion of the shaft proximate the base; and a compression spring positioned over the shaft with one end of the compression spring at the collar and an opposing end of the compression spring compressed against the reset sleeve. The collar is movable on the shaft to either compress the compression spring between the collar and the reset sleeve or to relax the compression spring between the collar and the reset sleeve. A compression or a relaxation of the compression spring alters an operational force used to move the shaft relative to the base.

In accordance with another aspect, a joystick for an electrically-powered wheelchair comprises: a shaft pivotally mounted in a base and configured to control a movement of the electrically-powered wheelchair; a collar threadedly received on an upper portion of the shaft; a reset sleeve positioned over a lower portion of the shaft proximate the base; a compression spring positioned over the shaft with one end of the compression spring coupled to or compressed against the collar and an opposing end of the compression spring compressed against the reset sleeve; and an actuator associated with the collar to rotate the collar. The collar is movable on the shaft to either compress the compression spring between the collar and the reset sleeve or to relax the compression spring between the collar and the reset sleeve. A compression or a relaxation of the compression spring alters an operational force used to move the shaft relative to the base.

### BRIEF DESCRIPTION OF THE DRAWINGS

The foregoing aspects and other features are explained in the following description, taken in connection with the accompanying drawings, wherein:

FIG. 1A is a perspective view of a joystick for an electrically-powered wheelchair;

FIG. 1B is a perspective cutaway view of the joystick of FIG. 1A;

FIGS. 1C-1E are side cutaway views of the joystick of FIG. 1A;

FIG. 2A is a perspective view of one exemplary embodiment of a joystick with a gaiter (18) removed;

FIGS. 2B-2D are side cutaway views of the joystick of FIG. 2A;

FIG. 3 is a perspective view of a C-clip for the joystick of FIGS. 2A-2D;

FIGS. 4A-4C are side cutaway views of another example embodiment of a joystick employing a nut/threaded shaft combination for compression and expansion of a spring; and

FIG. 5 is a side cutaway view of another example embodiment of a joystick employing an electrical actuator for compression and expansion of a spring.

### DETAILED DESCRIPTION OF EMBODIMENTS

Although the invention will be described with reference to the example embodiments shown in the drawings, it should be understood that the invention can be embodied in many alternate forms. In addition, any suitable size, shape, or type of elements or materials could be used.

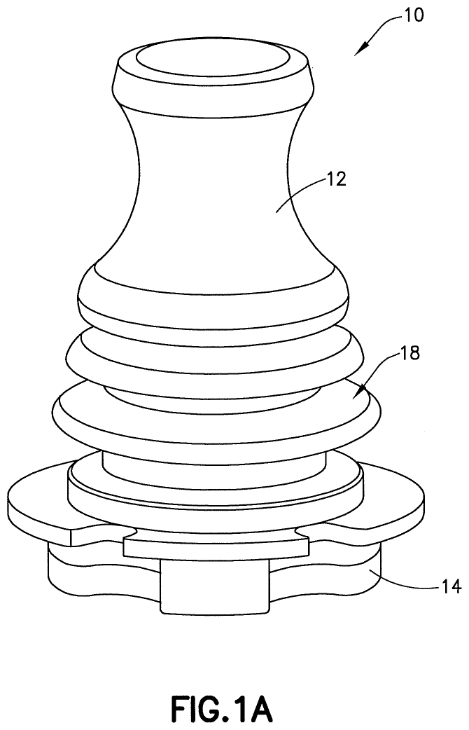

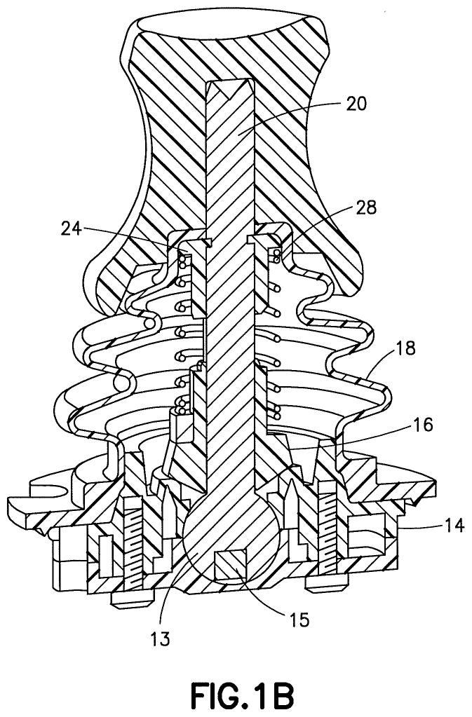

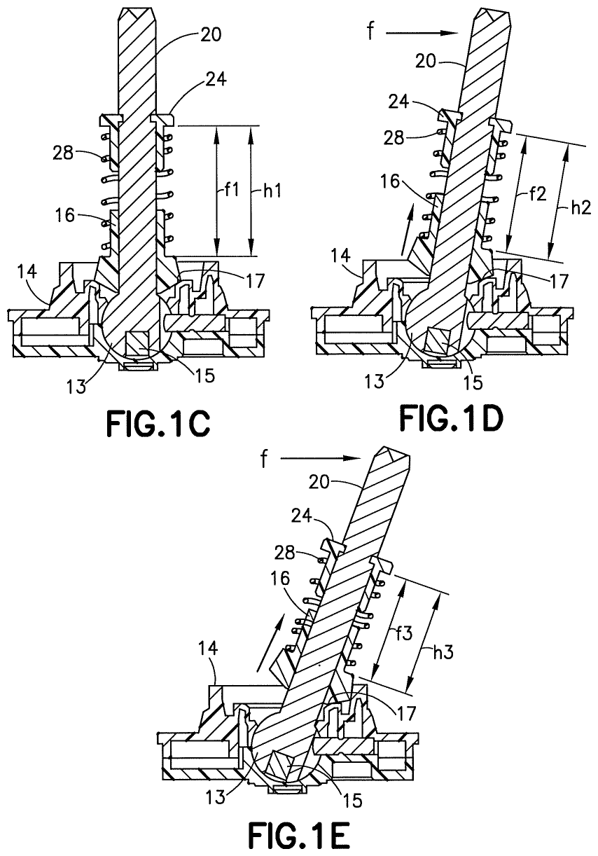

Referring to FIGS. 1A-1E, one example of a joystick for use as an input device for an electrically-powered wheelchair is shown generally at 10 and is hereinafter referred to as “joystick 10.”

The joystick 10 comprises a knob 12 located on an upper end of a shaft (shown at 20 in FIGS. 1B-1E) that is operably coupled to and pivotal on a base 14. A lower end of the shaft 20 is mounted in the base 14 and is configured as a ball 13. The ball 13 includes a magnet 15 that produces a magnetic field that may be detected by one or more sensors. The sensor(s) may be Hall sensors, which may be part of the joystick 10 or mounted below the magnet 15 on a printed circuit board. Changes detected in the magnetic field by the sensor(s) are used to impart operable functions (such as steering) to the wheelchair.

As shown in FIGS. 1B-1E, a reset sleeve 16 is positioned on and freely moves over the shaft 20. The reset sleeve 16, in conjunction with a spring 28, operates to move the joystick 10 back into a center position (FIG. 10) if no operating force is applied to the joystick 10.

As shown in FIGS. 1C-1E, a curved edge 17 in the base 14 engages a lower surface of the reset sleeve 16 to move the reset sleeve 16 along the shaft 20 when the joystick 10 is moved from the center position. The spring 28, which is a compression spring, is coupled to or abutted against a collar 24 on the upper end of the shaft 14. In the center position (FIG. 10), the spring 28 presses on the reset sleeve 16 with force f₁, and the spring 28 is at a maximum height h₁. When the joystick 10 is moved from the center position by an operational force applied by a user (FIG. 1D), the spring 28 urges the reset sleeve 16 back into the base 14 with a greater force f₂ and compression of the spring 28 to a lesser height h₂, thus urging the joystick 10 to return to the center position (FIG. 10). As the joystick 10 is moved even more, as in FIG. 1E, the force f₃ is increased and the height is reduced even further to h₃ in an effort to move the joystick 10 back to the center position. As the load on the spring 28 increases (f₁ to f₃), the operating force required by the user to move the joystick 10 away from the center position will correspondingly increase.

A flexible gaiter 18, as shown in FIGS. 1A and 1B, is positioned over the shaft 20 with an upper end of the gaiter 18 coupled to the lower end of the knob 12 or to the shaft 20 under the knob 12 and a lower end of the gaiter 18 coupled to the base 14. In operation of the joystick 10, the pivotal movement of the shaft 20 relative to the base 14 in a selected direction is made to energize an electrical circuit (via magnet/sensor arrangement), thereby corresponding to a movement or other operation (such as stopping) of the wheelchair.

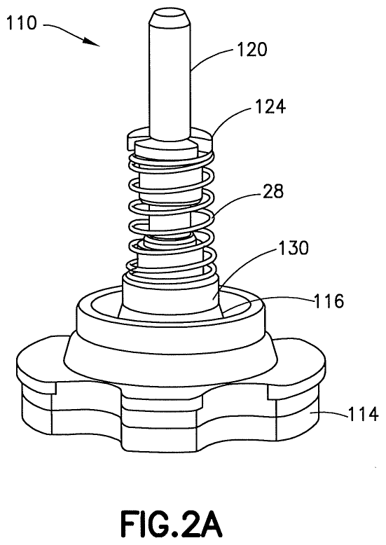

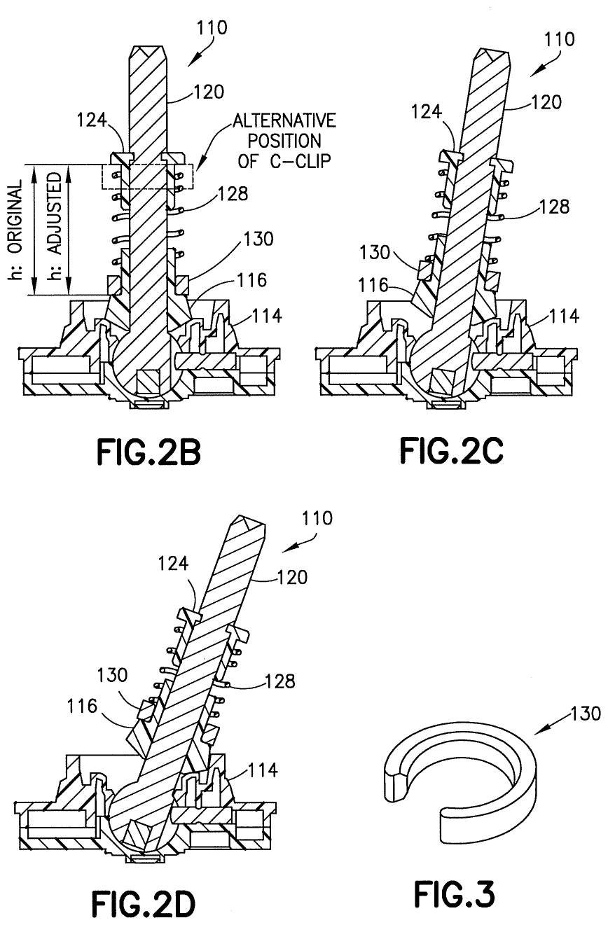

Referring to FIGS. 2A-2D, one example embodiment of a joystick for use as an input device for an electrically-powered wheelchair is shown generally at 110 and is hereinafter referred to as “joystick 110.” Although the description herein refers to the use of the joystick 110 with an electrically-powered wheelchair (or simply wheelchair), it should be understood that the joystick 110 may be used with any other type of powered personal mobility vehicle. The joystick 110 is shown with the knob and the gaiter removed. The joystick 110 is similar to joystick 10 and has a reset sleeve 116 on a shaft 120 mounted in a base 114 with an upper section of the shaft 120 including a collar 124 integrally formed with or attached to the shaft 120. A spring 128 in the form of a compression spring may be coupled to or abutted against the collar 124 and positioned over a lower end of the shaft 120 to urge the reset sleeve 116 into the base 114. In some embodiments, the collar 124 may not be present, and the spring 128 may be coupled to an upper part of the shaft 120 using any suitable means.

A C-clip 130 or clip 130 is positioned over the shaft 120 and between a lower end of the spring 128 and the reset sleeve 16. Positioning the clip 130 over the shaft 120 and between a free-moving end of the spring 128 and the reset sleeve 16 causes the spring 128 to be compressed more than if the clip 130 was not in place. As with FIGS. 1A-1E, compression of the spring 128 increases the operational force required by the user to move the shaft 120 in any direction, which in turn requires that a specific amount of operational force be exerted by the user for movement of the joystick 110. Multiple clips 130 may be positioned on the shaft 120 to further compress the spring 128 to require greater operational force for movement of the joystick 110. Although the joystick 110 is shown with the spring 128 being coupled to the shaft 120 at an upper end and the clip 130 removably positioned at the lower end of the spring 128, it should be understood that the spring 128 may be coupled to a lower end of the shaft 120 and the clip 130 positioned at the upper end. As with joystick 10, as the joystick 110 is moved from a center position (FIGS. 2A and 2B) and to a pivoted position (FIG. 2C), the force required to move the joystick 110 increases. As the joystick 110 is pivoted further (FIG. 2D), the force is further increased.

If the user wants to make the joystick 110 easier to pivot or otherwise maneuver, the clip 130 can be removed. Removal of the clip 130 from the shaft 20 accordingly causes the spring 128 to relax and expand and be less compressed, thereby causing the joystick 110 to be movable with a decreased amount of operational force (for example, as a result of a decrease in the user's strength/mobility) as compared to the configuration in which the clip 130 is used.

Referring now to FIG. 3, the clip 130 is of an open ring-type of structure and approximates a “C” shape. The clip 130 is fabricated from a material that allows the ends of the clip 130 that define the open portion to sufficiently flex to allow the clip 130 to “snap” over or otherwise be received on the shaft 120. Materials from which the clip 130 may be fabricated include, but are not limited to, plastics (such as thermoplastics or thermosets), steels (such as stainless steel), shape memory metals, and the like.

The foregoing embodiment provides several advantages over current joystick-type control devices. First, use of or removal of the clip(s) 130 is simple as compared to replacement of the spring. The clip 130 as supplied with the wheelchair can be removed by the user without resorting to service calls to the manufacturer or dealer. Second, only one spring 128 is used, thus removing the need to supply additional springs with the wheelchair and avoiding having to store the additional springs. Third, the clip 130 allows for easily scalable operating forces on the joystick 110 in that multiple clips 130 can be used and the operational force used to maneuver the joystick 110 changed as needed (for example, as the user's ability to operate the joystick 110 changes).

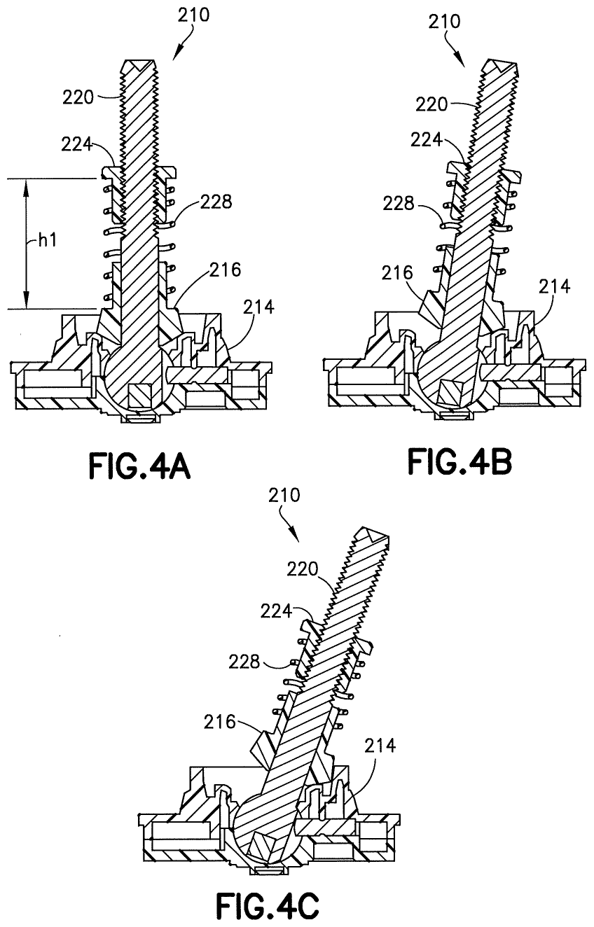

Referring to FIGS. 4A-4C, another example embodiment of a joystick is shown generally at 210. Instead of a clip 130 as shown in FIGS. 2A-2D, joystick 210 utilizes a nut/thread combination with a shaft to either compress or allow expansion (relaxation) of the spring. In particular, with the knob and gaiter removed, a lower end of a shaft 220 is pivotally mounted in a base 214 (similar to FIGS. 2A-2E) such that the shaft 220 extends upward. A reset sleeve 216 is positioned on a lower section of the shaft 220.

An upper section of the shaft 220 is threaded, and a nut or collar 224 having a corresponding thread is received on the threaded section of the shaft 220. A spring 228 in the form of a compression spring is positioned over the shaft 220 and between a downward-facing surface of the collar 224 and an upper-facing surface of the reset sleeve 216. The adjustability of the force used to move the joystick 210 is derived from rotation of the collar 224 such that the collar 224 translates along the length of the shaft 220 either compressing the spring 228 or allowing the spring 228 to expand. Compression or expansion of the spring 228, as with compression or expansion of the spring 128, allows the operational force needed to pivot the joystick 210 to be adjustable based on the user's strength.

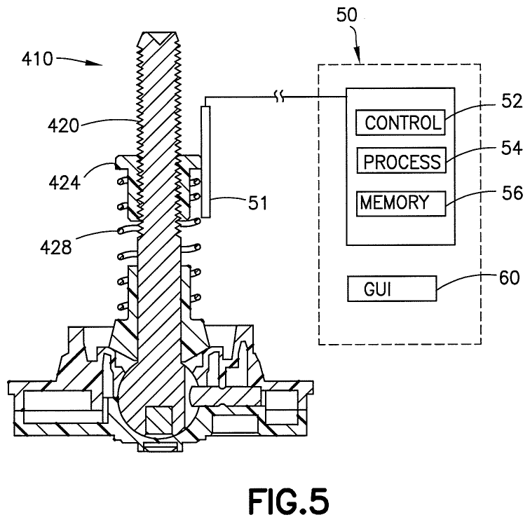

Referring to FIG. 5, another example embodiment of a joystick is shown generally at 410. Joystick 410 may employ a combination of a threaded collar 424 on a shaft 420 having a threaded upper section such that movement of the collar 424 along the shaft 420 either compresses or allows expansion of a spring 428 similar to joysticks 110 and 210, but the collar 424 may be rotatable on the shaft 420 using an actuator 50 operably coupled to the collar 424 and configured to cause the rotation of the collar 424 on the shaft 420. The actuator 50 may be electric and configured to cause movement of a roller 51 (or any other suitable apparatus) that rotates the collar 424. The actuator 50 may cause controlled movement of the roller 51 via a controller 52 comprising a processor 54 having an associated memory 56 and suitable software. Any suitable user interface 60 (such as a graphical user interface on a control panel on the wheelchair or on a smartphone) may be associated with the actuator 50 and/or controller 52 to allow a user to control the compression and expansion of the spring 428. Joystick 410 is not limited to the use of a collar/threaded shaft combination as shown, however, as any suitable mechanism capable of being actuated using the controller 52 may be incorporated and used to compress and expand the spring 428. As with previous embodiments, compression or expansion of the spring 428, which in this embodiment is controlled via the controller 52, allows the operational force needed to pivot the joystick 410 to be adjustable based on the user's strength.

One example embodiment of a joystick for an electrically-powered wheelchair comprises: a shaft pivotally mounted in a base and configured to control a movement of the electrically-powered wheelchair; a reset sleeve positioned over a lower portion of the shaft proximate the base; a compression spring positioned over the shaft with one end of the compression spring compressed against or fixed to an upper portion of the shaft and an opposing end of the compression spring compressed against the reset sleeve; and a flexible clip positioned over the shaft at the opposing end of the compression spring and between the compression spring and the reset sleeve, the flexible clip being removably positioned on the shaft so as to compress the compression spring between the flexible clip and a point at which the compression spring is compressed against or fixed to the upper portion of the shaft. A compression or a relaxation of the compression spring alters an operational force used to move the shaft relative to the base.

The joystick may further comprise a flexible gaiter positioned between an upper end of the shaft and the base. The joystick may further comprise a knob positioned at the upper end of the flexible gaiter. The flexible clip may be configured in the shape of a C such that ends of the flexible clip flex to allow the flexible clip to engage the shaft. The flexible clip may comprise a plastic, stainless steel, or a shape memory metal. The one end of the compression spring may be coupled to a collar on the shaft.

Another example embodiment of a joystick for an electrically-powered wheelchair comprises: a shaft pivotally mounted in a base and configured to control a movement of the electrically-powered wheelchair; a collar threadedly received on an upper portion of the shaft; a reset sleeve positioned over a lower portion of the shaft proximate the base; and a compression spring positioned over the shaft with one end of the compression spring at the collar and an opposing end of the compression spring compressed against the reset sleeve. The collar is movable on the shaft to either compress the compression spring between the collar and the reset sleeve or to relax the compression spring between the collar and the reset sleeve. A compression or a relaxation of the compression spring alters an operational force used to move the shaft relative to the base.

The one end of the compression spring may be coupled to the collar and the opposing end of the compression spring may be loosely positioned over the lower portion of the shaft against the reset sleeve. The one end of the compression spring may be compressed against the collar and the opposing end of the compression spring may be loosely positioned over the lower portion of the shaft against the reset sleeve. The shaft may comprise a ball pivotally coupled to the base. The joystick may further comprise a flexible gaiter positioned between an upper end of the shaft and the base.

Another example embodiment of a joystick for an electrically-powered wheelchair comprises: a shaft pivotally mounted in a base and configured to control a movement of the electrically-powered wheelchair; a collar threadedly received on an upper portion of the shaft; a reset sleeve positioned over a lower portion of the shaft proximate the base; a compression spring positioned over the shaft with one end of the compression spring coupled to or compressed against the collar and an opposing end of the compression spring compressed against the reset sleeve; and an actuator associated with the collar to rotate the collar. The collar is movable on the shaft to either compress the compression spring between the collar and the reset sleeve or to relax the compression spring between the collar and the reset sleeve. A compression or a relaxation of the compression spring alters an operational force used to move the shaft relative to the base.

The actuator may be electric and may be configured to cause a rotation of the collar to move the collar over the threads of the shaft. The actuator may comprise a processor having an associated memory and software, the operation of which may control a movement of the collar over the threads of the shaft. The joystick may further comprise a user interface through which the actuator can be controlled by a user.

It should be understood that the foregoing description is only illustrative. Various alternatives and modifications can be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modifications, and variances which fall within the scope of the appended claims.

1. A joystick for an electrically-powered wheelchair, the joystick comprising:
a shaft pivotally mounted in a base and configured to control a movement of the electrically-powered wheelchair;
a reset sleeve positioned over a lower portion of the shaft proximate the base and configured to move with the shaft;
a compression spring positioned over the shaft with one end of the compression spring compressed against or fixed to an upper portion of the shaft; and
a flexible clip positioned over the shaft at an opposing end of the compression spring and between the compression spring and the reset sleeve, the flexible clip being removably positioned on the shaft so as to compress the compression spring between the flexible clip and a point at which the compression spring is compressed against or fixed to the upper portion of the shaft;
wherein a compression or a relaxation of the compression spring alters an operational force used to move the shaft relative to the base.

2. The joystick of claim 1, further comprising a flexible gaiter positioned between an upper end of the shaft and the base.

3. The joystick of claim 2, further comprising a knob positioned at the upper end of the flexible gaiter.

4. The joystick of claim 1, wherein the flexible clip is configured in the shape of a C such that ends of the flexible clip flex to allow the flexible clip to engage the shaft.

5. The joystick of claim 4, wherein the flexible clip comprises a plastic, stainless steel, or a shape memory metal.

6. The joystick of claim 1, wherein the one end of the compression spring is coupled to a collar on the shaft.

7. A joystick for an electrically-powered wheelchair, the joystick comprising:
a shaft pivotally mounted in a base and configured to control a movement of the electrically-powered wheelchair;
a collar threadedly received on an upper portion of the shaft;
a reset sleeve positioned over a lower portion of the shaft proximate the base; and
a compression spring positioned over the shaft with one end of the compression spring at the collar and an opposing end of the compression spring compressed against the reset sleeve;
wherein the collar is movable on the shaft to either compress the compression spring between the collar and the reset sleeve or to relax the compression spring between the collar and the reset sleeve;
wherein a compression of the compression spring by a first movement of the collar on the shaft causes an amount of operational force used to move the shaft relative to the base to increase as the shaft is moved away from a neutral position and wherein a relaxation of the compression spring by a second movement of the collar on the shaft causes a movement of the shaft to a neutral position.

8. The joystick of claim 7, wherein
the one end of the compression spring is coupled to the collar and the opposing end of the compression spring is positioned over the lower portion of the shaft against the reset sleeve.

9. The joystick of claim 7, wherein the one end of the compression spring is compressed against the collar and the opposing end of the compression spring is positioned over the lower portion of the shaft against the reset sleeve.

10. The joystick of claim 7, wherein the shaft comprises a ball pivotally coupled to the base.

11. The joystick of claim 7, further comprising a flexible gaiter positioned between an upper end of the shaft and the base.

12. A joystick for an electrically-powered wheelchair, the joystick comprising:
a shaft pivotally mounted in a base and configured to control a movement of the electrically-powered wheelchair;
a collar threadedly received on an upper portion of the shaft;
a reset sleeve positioned over a lower portion of the shaft proximate the base and configured to move with the shaft;
a compression spring positioned over the shaft with one end of the compression spring coupled to or compressed against the collar; and
an actuator associated with the collar to rotate the collar;
wherein the collar is movable on the shaft to either compress the compression spring between the collar and the reset sleeve or to relax the compression spring between the collar and the reset sleeve; and
wherein a compression or a relaxation of the compression spring alters an operational force used to move the shaft relative to the base.

13. The joystick of claim 12, wherein the actuator is electric and is configured to cause a rotation of the collar to move the collar over the threads of the shaft.

14. The joystick of claim 12, wherein the actuator comprises a processor having an associated memory and software, the operation of which controls a movement of the collar over the threads of the shaft.

15. The joystick of claim 12, further comprising a user interface through which the actuator can be controlled by a user.
